(19) United States
(12) Patent Application Publication
(10) Pub. No.: US 2007/0245947 A1
(43) Pub. Date: Oct. 25, 2007

(54) Indicating Device for Displaying the Temperature History of an Object Over Time

(76) Inventor: John Riemelmoser, Salisbury Heights (AU)

Correspondence Address: Klauber & Jackson LLC;Continental Plaza, 411 Hackensack Avenue, 4th Floor, Hackensack, NJ, 07601, US

(21) Appl. No.: 11/630,214

(22) PCT Filed: Jun. 21, 2005
(86) PCT No.: PCT/AU05/00882

§ 371 Date: Dec. 20, 2006

(30) Foreign Application Priority Data
Jun. 21, 2004 (AU) 2004903326

(51) Int. Cl. G01K 3/04

(52) U.S. Cl. 116/217; 374/102

(57) ABSTRACT

An indicating device (100) for displaying temperature history of an object over time includes, a reservoir (40) of indicating material secured with respect to said object, the indicating material being solid below a predetermined temperature and liquid at or above this predetermined temperature; a wicking member (30) arranged with respect to the reservoir so that the indicating material is able to migrate from the reservoir through the wicking member to a peripheral portion spaced from the reservoir; and indicator means spaced from the reservoir so that migration of the indicating material to the indicator means indicates a predetermined temperature history; wherein said indicator means includes a barrier member (20) located on the wicking member and having a barrier region positioned between the reservoir and said peripheral portion of the wicking member and wherein said barrier member prevents viewing of the migration of the indicating material through the wicking member until it migrates past said barrier region of the barrier member.

### FIELD OF THE INVENTION

This invention relates to an indicating device that is able to display the temperature history of an object over a period of time.

### BACKGROUND OF THE INVENTION

The invention will be to provide an indication when an object has been exposed to a predetermined temperature for a predetermined period of time. It will have numerous applications, however it will be particularly useful in relation to packaged food products including dairy products such as milk.

Milk is commonly sold in cardboard cartons and safe handling practices, as well as Government regulations, require that such products not be exposed to temperatures above a predetermined level for a set length of time. In the case of milk, the product should not be exposed to temperatures above 5 degrees for more than 15 minutes.

The industry meets these requirements by ensuring that such products are always stored or kept in adequate refrigerated conditions. However, this is not always possible, particularly during transport and delivery of such products. It is not uncommon for crates of milk cartons to sit for extended periods of time on loading docks awaiting movement from delivery points to refrigerated storage.

Accordingly, despite best endeavours, it is still possible for such products to be exposed to elevated temperatures well beyond stipulated time even though the conditions of transport and storage meet the legal requirements.

Accordingly, it would be desirable to provide an indicating means which will show when packaged products have been subject to elevated temperatures for a time that is greater than allowable.

An example of such indicating devices is shown in U.S. Pat. No. 5,120,137. Such devices make use of an indicating material which is normally solid below a predetermined temperature. The indicating material becomes liquid at or above a predetermined temperature. A wicking material comprising a woven or non-woven fibrous material is placed adjacent the indicating material so that when it is in its liquid phase, the indicating material, which is pigmented, migrates along the wicking material. A mask having apertures is located above the wicking material and spaced at intervals from the location of the reservoir of indicating material. Provided that the indicating material is held at a temperature that is at or above its liquid phase temperature, then the indicating material will move along the wicking material at a constant rate. Accordingly, as the indicating material becomes visible in the apertures within the mask it in turn indicates the time for which the indicating material has been in its liquid phase.

Should the device as a whole be reduced in temperature to below the predetermined temperature, then the indicating material in both the reservoir and the wicking material will become solid and therefore the migration of the indicating material will cease. Accordingly, the device will provide an indication of the total time spent above the predetermined temperature even though this may have occurred at different intervals.

The device shown in U.S. Pat. No. 5,120,137 has an adhesive backing and also uses a barrier strip that is positioned between the indicator material to prevent operation of the indicator until required. Adhesive backing enables the device to be attached to an article and it can be activated by removing the barrier strip.

The above mentioned product has several disadvantages which include the need to remove the barrier strip to activate its operation. Further, the product does not lend itself to application in mass production processes such as filling of milk cartons.

It is an object of the present invention to seek to overcome these problems and to provide an article that is of much simpler construction which will provide an indication of the temperature history of an article.

### SUMMARY OF THE INVENTION

In a first aspect the present invention accordingly provides an indicating device for displaying temperature history of an object over time including;

a reservoir of indicating material secured with respect to said object, said indicating material being solid below a predetermined temperature and liquid at or above said predetermined temperature,

a wicking member arranged with respect to said reservoir so that said indicating material is able to migrate from said reservoir through said wicking member to a peripheral portion of said wicking member spaced from said reservoir, and

indicator means spaced from said reservoir so that migration of said indicating material to said indicator means indicates a predetermined temperature history.

Clearly this indicator device is of a simpler construction then those of the prior art making it suitable to be attached to mass produced items.

Preferably, said indicator means includes a barrier member located on said wicking member, said barrier member having a barrier region positioned between said reservoir and said peripheral portion of said wicking member and wherein said barrier member prevents viewing of the migration of said indicating material through the wicking member until it migrates past the barrier region of said barrier member.

Use of the barrier member provides an extremely effective visual indication of the temperature history of an object providing a simple “yes” or “no” indication of whether a predetermined temperature has been attained for a predetermined time.

Preferably, said barrier member includes a thin non-transparent and water proof material that does not absorb the indicating material.

Preferably, said wicking member includes a layer of woven or non-woven fibrous material selected to allow the migration of said liquid indicating material to progress at a predetermined rate evenly along the wicking member.

Preferably, migration of said liquid indicating material is caused by capillary action acting on the liquid indicating material.

Capillary action acting on a liquid is a well understood and characterised process which improves the accuracy and precision of the temperature indicating device.

Preferably, said reservoir includes a porous material that is able to absorb or hold the indicating material.

Preferably, said porous material is saturated with said indicating material and said wicking member is located over said reservoir.

Preferably, said wicking member incorporates said reservoir of indicating material.

In this manner the number of components or layers in the indicating device can be advantageously reduced.

Preferably, said reservoir of indicating material is incorporated into said wicking member by absorbing said indicating material into a portion of said wicking member and then causing said indicating material to freeze as it soaks into the wicking member to remain in a localised position.

Preferably, said reservoir is located approximately centrally with respect to said wicking member and said barrier member.

Preferably, said barrier member is substantially circular.

Optionally, said barrier member is substantially rectangular.

These configurations provide clear indications of when a particular temperature history has been met and depending on the requirements either circular or rectangular barrier members may be more suitable.

Optionally, said reservoir is located approximately to one edge of said wicking material.

This configuration provides for migration of the liquid indicating material in one direction which may be preferable for certain applications.

Optionally, said indicator means includes a line on the surface of said wicking member.

This also further simplifies the construction of the indicating device.

Preferably, said indicating device includes a top layer of transparent material having an adhesive underside.

In a second aspect the present invention provides a continuous tape of temperature indicating devices, said tape including a plurality of individual indicating devices according to a first aspect of the invention spaced apart along a continuous web.

In this manner a continuous strip of indicating devices can be manufactured and stored as a roll. This roll can form part of a dispensing step where individual indicating devices are dispensed from the roll to be applied to the object whose temperature history is to be monitored.

In a third aspect the present invention accordingly provides a temperature indicating device for displaying temperature history of an object over time, said device including;

a first base layer having an adhesive surface for attachment to said object;

a second layer incorporating a reservoir of indicating material, said indicating material being solid below a predetermined temperature and liquid at or above said predetermined temperature, said reservoir being secured to said object,

a third layer including a wicking member arranged with respect to said reservoir so that said indicating material is able to migrate from said reservoir through said wicking member to a peripheral portion of said wicking member spaced from said reservoir,

a fourth layer including a barrier member located on said third layer, said barrier member having a barrier region positioned between said reservoir and said peripheral portion of said wicking member, wherein said barrier member prevents viewing of the migration of said indicating material through the wicking member until it migrates past the periphery region of said barrier region.

### BRIEF DESCRIPTION OF THE DRAWINGS

A preferred embodiment of the present invention will be discussed with reference to the accompanying drawings wherein:

FIG. 1 is an exploded view of the indicating device according to a first embodiment of the present invention;

FIG. 2 is an assembled view of the indicating device as illustrated in FIG. 1;

FIG. 3 is a sequence of illustrations showing the operation of the indicating device illustrated in FIG. 2;

FIG. 4 is a layered view of a temperature indicating device according to a second embodiment of the present invention; and

FIG. 5 is a top view of a temperature indicating device according to a third embodiment of the present invention.

In the following description, like reference characters designate like or corresponding parts throughout the several views of the drawings.

### DESCRIPTION OF PREFERRED EMBODIMENT

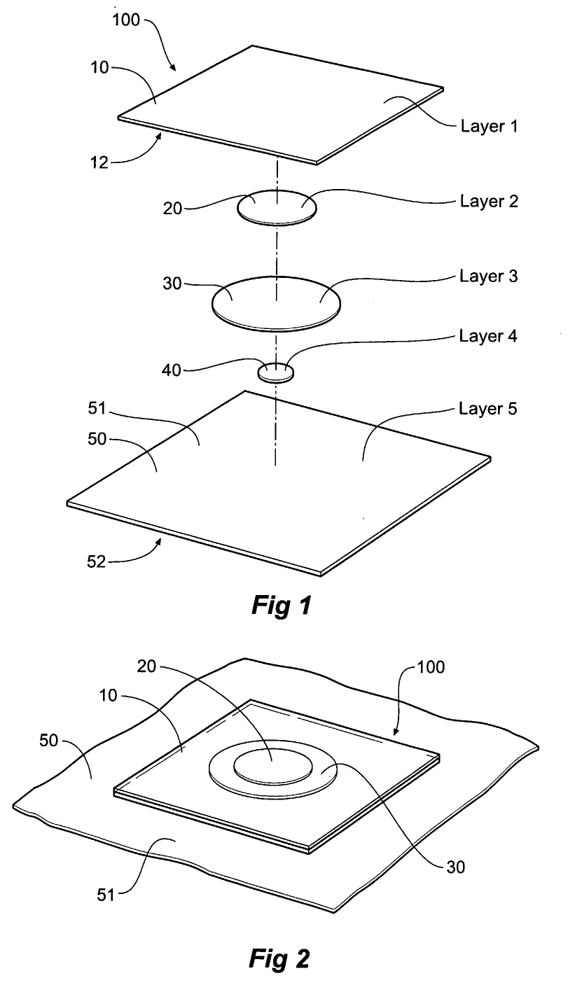

Referring to FIG. 1, it shows a temperature indicating device 100 according to a first embodiment of the present invention including a number of layers 1 to 5. FIG. 1 also shows the relative size of the various components between layers 1 and 5.

Layers 1 and 5 are formed of a polymeric film 10, 50 with layer 5 as thin as possible to ensure good heat conductivity. Layer 5 has adhesive applied to both sides 51, 52.

Layer 4 includes a reservoir 40 of indicating material and in this embodiment reservoir 40 is blotting paper impregnated with a coloured organic compound such as a fatty acid or an alcohol or their derivatives. As an alternative to blotting paper, any form of sponge or woven or non-woven fibrous material could also be employed as the reservoir.

Layer 3 includes the wicking member 30 which is a thin sheet of blotting paper. Alternatively, any form of woven or non-woven sheet material having the required wicking properties would be suitable.

The wicking member 30 is shown as having a much larger diameter than the reservoir 40. The reservoir 40 and wicking member 30 are shown as being circular with the reservoir 40 being located centrally with respect to the wicking member 30.

Layer 2 is a non-transparent film functioning as a barrier member or gauge 20. The barrier member 20 is circular with its periphery located centrally within the wicking member 30. The diameter of the barrier member 20 is larger than the indicator reservoir 40. In this manner, a barrier region of the barrier member 20 is located between the reservoir 40 and an exposed peripheral portion of wicking member 30.

The first layer is located over the top of both layer 2 and layer 3 and also adheres to layer 5. In this way, the various layers are bound together and the overall thickness of indicating device 100 can be kept to a minimum.

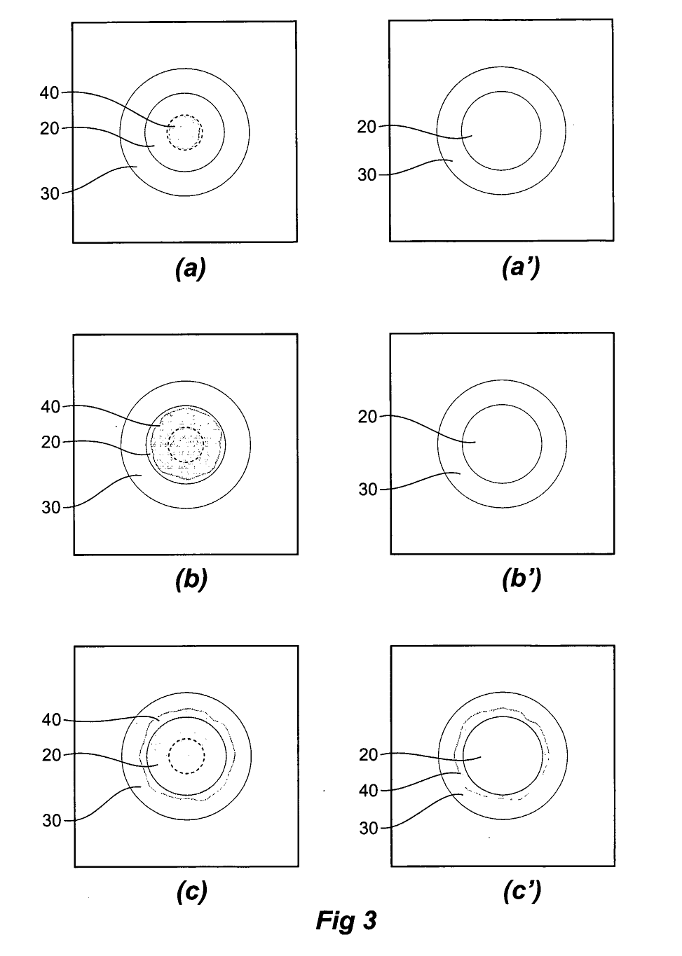

FIG. 2 shows an assembled view of indicating device 100 and FIG. 3 represents, in stages, the operation of the indicating device 100. The images shown on the left of FIG. 3 are as though the barrier member or gauge 20 were transparent to illustrate the progression or migration of the indicating material in the wicking member 30.

Referring to FIGS. 3(a) and (a′), the indicator material is contained wholly within the reservoir 40 and has not migrated into the wicking member 30 (i.e. layer 3). Referring now to FIGS. 3(b) and (b′), with some exposure to heat, the indicator material migrates from reservoir 40 into the wicking member 30 and extends outwardly from the reservoir 40. However, this movement is not visible as indicated by FIG. 3(b′) as the spread of the indicating material is beneath the barrier member 20 (i.e. layer 2).

Referring now to FIGS. 3(c) and (c′), once the indicating material extends beyond the periphery region of the barrier member 20, it becomes visible. This then provides positive visual indication of the indicating material having being liquid for a time determined by the distance between the reservoir 40 and the periphery of the barrier member 20.

Thus the indicating device according to this embodiment provides a positive “yes” or “no” visual indication as to whether or not a particular temperature history has been met.

Alternatively, instead of using a barrier member or gauge 40 on top of the wicking member 30, the wicking member 30 may have indicator means in the form of graduation markings or lines which indicate a predetermined temperature history. Accordingly, a circumferential gauge line may be drawn on to the upper surface of the wicking member 30 at a diameter which indicates a predetermined temperature history. In this case, the indicating material would be visible at all times within the wicking member 30 and given the radial position of the indicating material in relation to the gauge line will indicate the extent to which the indicating material has reached any temperature above the predetermined temperature while at the same time also indicating the predetermined temperature history once the indicating material reaches the gauge marking.

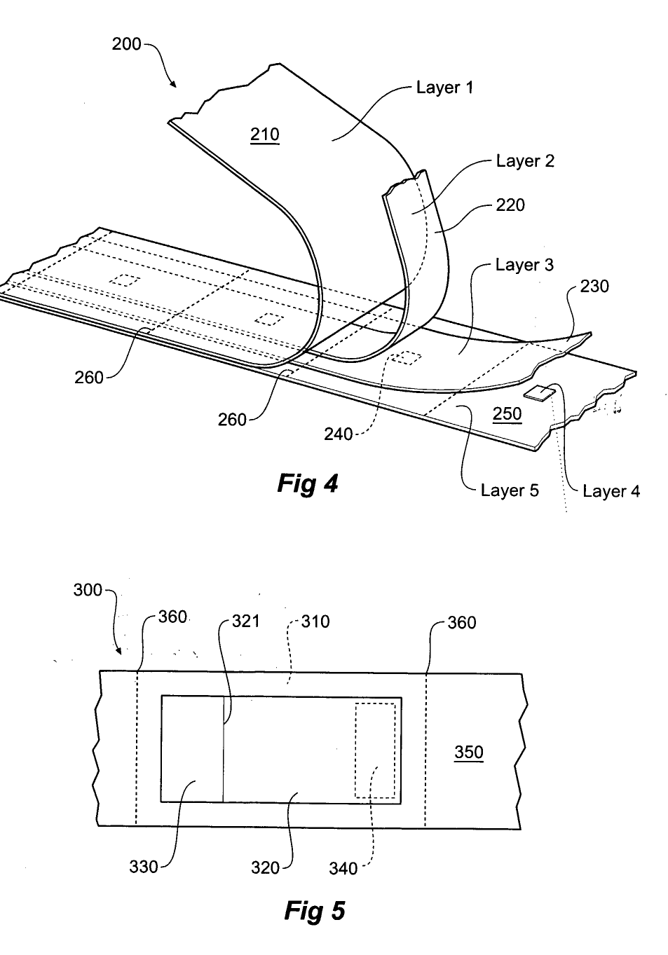

The embodiment shown in FIGS. 1 to 3 uses circular wicking and barrier members 30, 20. Referring now to FIG. 4, there is shown an indicating device 200 according to another embodiment of the present invention incorporating different shaped members such as the wicking member 230 including a continuous band of wicking material layed on to the base layer 5. The reservoir 240 of layer 4 in this embodiment is still located in the middle of wicking member 230 and the barrier member or gauge 220 could either be circular or may also include a continuous band (as illustrated in FIG. 4) located centrally within the band of the wicking member 220. In this case, the indicating material would only become visible on the edges of the barrier band 220.

Referring now to FIG. 5, there is shown an indicating device 300 according to another embodiment of the present invention. As shown in FIG. 5, it is not essential that the reservoir 340 of indicating material be placed centrally with respect to the wicking member 330. The present invention will work equally as well if the indicating material reservoir 340 is placed at one edge of the wicking member 330 so that the indicating material becomes visible only along a portion of the peripheral edge 321 of the barrier member 320. In this embodiment, wicking member 330 is an elongate band with the indicating material reservoir 340 located at one end of the band and the barrier member 320 extends from the reservoir end of wicking member 330 to a position short of the other end of the wicking member 330. In this case, the barrier member 320 may overlie the edges of the wicking member band 330 so that the indicating material only becomes visible once it migrates far enough along the wicking member 330 to then become visible at the end of the barrier member band 320. Alternatively, indicating means in the form of a graduation line or lines may be used in place of the barrier member.

To manufacture the various embodiments described above, the 1st and 5th layer may be formed continuously with layers 2 to 4 being positioned either continuously or at regular intervals along the length of these continuous bands. Part of the process will be forming score lines or perforations 260, 360 between adjacent indicating devices so that they can be easily separated during the process of applying them for example to packaging.

During the manufacturing process, it would be necessary to maintain the various layers below the predetermined temperature which would keep the indicating material solid. The formed indicating devices will in turn need to be maintained at this lower temperature prior to application to packaging.

Once applied to the packaging, the indicating material will only become liquid and migrate within the wicking material upon the predetermined temperature being reached. Provided this temperature is maintained either continuously or intermittently, then, over a period of time, the indicating device will provide a positive visual indication that a predetermined temperature history has been attained. In the case of packaged perishable food items, this will enable consumers to ensure that products have been maintained at required temperatures prior to their purchase. Any products not meeting these requirements will clearly become identifiable.

As would be apparent to those skilled in the art, there will be a temperature gradient between the core temperature of the object and the air temperature surrounding the object. Accordingly, there will be a region of transition of temperature so that the surface of the object will be above the temperature of the core of the object but below the temperature of the surrounding air mass. Accordingly, the actual predetermined temperature can be proportionally lower to take into account the likely temperature gradient.

In the previously described embodiments the indicating device will respond primarily to temperature changes at the surface of the object to which it is attached and to some extent the air temperature around its location. To make the indicating device more responsive to the surrounding air temperature, layer 5 may be formed from an insulating material thereby forming a heat conducting barrier between the object and the reservoir so that the indicating device becomes relatively more responsive to the air temperature around the object.

In another embodiment of the present invention, the wicking member may be adapted to directly incorporate the reservoir of indicating material. This can be achieved by absorbing said a predetermined amount of indicating material into a portion of the wicking member and then causing the absorbed material to freeze as it soaks into the wicking member thereby ensuring that it remains in a localised position.

Clearly, the indicating device would always need to be maintained at a temperature below the predetermined temperature to prevent the commencement of movement of indicating fluid into the wicking member. Accordingly, the manufacturing process and storage will need to occur below the predetermined temperature. Again, application of the indicating devices should preferably occur at a temperature below the predetermined temperature although this may of course form part of the relevant temperature history for the objects concerned.

The construction process according to the above embodiment ensures that external humidity will have minimal affect on the operation of the absorbent properties of the wicking member.

A brief consideration of the above described embodiments will indicate that the present invention provides an extremely simple and economical indicating device which on attachment to an object provides a clear visual indication of the temperature history of that object or the surrounding environment and can be manufactured as a continuous tape for ease of application to multiple objects.

Although a preferred embodiment of the present invention has been described in the foregoing detailed description, it will be understood that the invention is not limited to the embodiment disclosed, but is capable of numerous rearrangements, modifications and substitutions without departing from the scope of the invention as set forth and defined by the following claims.

1. An indicating device for displaying temperature history of an object over time including;
a reservoir of indicating material secured with respect to said object, said indicating material being solid below a predetermined temperature and liquid at or above said predetermined temperature,
a wicking member arranged with contact with said reservoir so that said indicating material migrates from said reservoir when in liquid form through said wicking member to a peripheral portion of said wicking member spaced from said reservoir, and
indicator means spaced from said reservoir so that migration of said indicating material to said indicator means indicates a predetermined temperature history.

2. An indicating device as claimed in claim 1, wherein said indicator means includes a barrier member located on said wicking member, said barrier member having a barrier region positioned between said reservoir and said peripheral portion of said wicking member and wherein said barrier member prevents viewing of the migration of said indicating material through the wicking member until it migrates past the barrier region of said barrier member.

3. An indicating device as claimed in claim 2, wherein said barrier member includes a thin non-transparent and water proof material that does not absorb the indicating material.

4. An indicating device as claimed in claim 1, wherein said wicking member includes a layer of woven or non-woven fibrous material selected to allow the migration of said liquid indicating material to progress at a predetermined rate evenly along the wicking member.

5. An indicating device as claimed in claim 4, wherein migration of said liquid indicating material is caused by capillary action acting on the liquid indicating material.

6. An indicating device as claimed in claim 1, wherein said reservoir includes a porous material that is able to absorb or hold the indicating material.

7. An indicating device as claimed in claim 6, wherein said porous material is saturated with said indicating material and said wicking member is located over said reservoir.

8. An indicating device as claimed in claim 7, wherein said reservoir is secured to a base layer and wherein said base layer includes an adhesive backing for attachment to said object.

9. An indicating device as claimed in claim 1, wherein said wicking member incorporates said reservoir of indicating material.

10. An indicating device as claimed in claim 9, wherein said reservoir of indicating material is incorporated into said wicking member by absorbing said indicating material into a portion of said wicking member and then causing said indicating material to freeze as it soaks into the wicking member to remain in a localised position.

11. An indicating device as claimed in claim 10, wherein said wicking member is secured to a base layer and wherein said base layer includes an adhesive backing for attachment to said object.

12. An indicating device as claimed in claim 2, wherein said reservoir is located approximately centrally with respect to said wicking member and said barrier member.

13. An indicating device as claimed in claim 12, wherein said barrier member is substantially circular.

14. An indicating device as claimed in claim 12, wherein said barrier member is substantially rectangular.

15. An indicating device as claimed in claim 2, wherein said reservoir is located approximately to one edge of said wicking material.

16. An indicating device as claimed in claim 1, wherein said indicator means includes a line on the surface of said wicking member.

17. An indicating device as claimed in claim 16, wherein said line includes the peripheral edge of said wicking member.

18. An indicating device as claimed in claim 1, further including top layer of transparent material having an adhesive underside.

19. A continuous tape of temperature indicating devices, said tape including a plurality of individual indicating devices according to claim 1 spaced apart along a continuous web.

20. A temperature indicating device for displaying temperature history of an object over time, said device including;
a first base layer having an adhesive surface for attachment to said object;
a second layer incorporating a reservoir of indicating material, said indicating material being solid below a predetermined temperature and liquid at or above said predetermined temperature, said reservoir being secured to said object,
a third layer including a wicking member arranged in contact with said reservoir so that said indicating material migrates from said reservoir when in liquid form through said wicking member to a peripheral portion of said wicking member spaced from said reservoir,
a fourth layer including a barrier member located on said third layer, said barrier member having a barrier region positioned between said reservoir and said peripheral portion of said wicking member, wherein said barrier member prevents viewing of the migration of said indicating material through the wicking member until it migrates past the periphery region of said barrier region.
